(19) United States
(12) Patent Application Publication
(10) Pub. No.: US 2011/0272356 A1
(43) Pub. Date: Nov. 10, 2011

(54) SEPARATION DEVICE HAVING COUPLED SEPARATION DEVICE ELEMENTS

(75) Inventor: Bernd HOFFMANN, Karlsdorf (DE)

(73) Assignee: AGILENT TECHNOLOGIES, INC., Santa Clara, CA (US)

(21) Appl. No.: 13/042,340

(22) Filed: Mar. 7, 2011

(30) Foreign Application Priority Data
May 4, 2010 (GB) 1007314.6

(51) Int. Cl. B01D 15/08; B01D 37/04

(52) U.S. Cl. 210/656; 210/198.2; 210/143

(57) ABSTRACT

A separation device has a first separation chamber for housing a packing material representing a stationary phase configured for separating compounds of a fluid sample. The separation device comprises a first separation device element and a second separation device element, configured to be coupled together to provide the first separation chamber. Each of the first separation device element and the second separation device element comprises a retaining element configured to retain the packing material within the first separation chamber. The first separation chamber is provided by the first separation device element and the second separation device, with the retaining elements of both the first separation device element and the second separation device closing the first separation chamber.

This application claims priority from United Kingdom Patent Application No. GB1007314.6, filed on 4 May 2010, which is incorporated by reference in its entirety.

The present invention relates to a separation device, in particular in a high performance liquid chromatography application.

### BACKGROUND

In high performance liquid chromatography (HPLC), a liquid has to be provided usually at a very controlled flow rate (e.g. in the range of microliters to milliliters per minute) and at high pressure (typically 5-60 MPa, 50-600 bar, and beyond up to currently 100 or even 120 MPa, 1000-1200 bar) at which compressibility of the liquid becomes noticeable. For liquid separation in an HPLC system, a mobile phase (for example a solvent) comprising a sample fluid (e.g. a chemical or biological mixture) with compounds to be separated is driven through a separation device (such as a chromatographic column) comprising a stationary phase, thus separating different compounds of the sample fluid which may then be identified and/or collected.

As the sample passes with the mobile phase through the stationary phase, the different compounds, each one having a different affinity to the stationary phase (e.g. the packing medium), move through the column at different speeds. Those compounds having greater affinity to the stationary phase move more slowly along the column than those having less affinity, and this time difference results in the compounds being separated from one another as they pass through the column. The column and its separation characteristic are usually configured to the sample. The term “compound”, as used herein, shall cover compounds which might comprise one or more different components. The stationary phase is subject to a mechanical—in special formats also to an electrical force generated in particular by a hydraulic pump or electric circuit—that pumps the mobile phase usually from an upstream connection of the column to a downstream connection of the column. As a result of flow, depending on the physical properties of the stationary phase and the mobile phase, a relatively high pressure drop results across the column.

The mobile phase with the separated compounds exits the column and passes through a detector, which identifies the molecules, for example by spectrophotometric absorbance measurements. A two-dimensional plot of the detector signal against elution time or volume, known as a chromatogram, may be made, and thus the compounds may be identified. Ideally, each compound becomes displayed as a separate curve or “peak” in the chromatogram. Effective separation of the compounds by the column is advantageous because it provides for measurements yielding well defined peaks having sharp maxima inflection points and narrow base widths, allowing excellent resolution and reliable identification of the mixture constituents. Broad peaks, caused by poor column performance, are undesirable as they may allow minor components of the mixture to be masked by major components and go unidentified.

An HPLC column typically comprises a stainless steel tube having a bore containing a packing material comprising, for example, derivatized silica spheres having a diameter between 0.5 to 100 μm, or 1-10 μm or even 1-5 μm. Typically, the material is packed under pressure in highly uniform bead layers which ensure a uniform flow of the transport liquid and the sample through the column to promote effective separation of the sample constituents. The packing material is contained within the bore by porous plugs, known as “frits”, positioned at opposite ends of the tube. The porous frits allow the transport liquid and the chemical sample to pass while retaining the packing material within the bore. After being filled, the column may be coupled or connected to other elements (like a control unit, a pump, containers including samples to be analyzed) by e.g. using fitting elements. Such fitting elements may contain porous parts such as screens or frit elements.

Further details about columns are described e.g. in US 2007221557 A1.

Various processes for filling (often also referred to as packing) columns are disclosed e.g. U.S. Pat. No. 4,483,773 A, U.S. Pat. No. 4,549,584 A, U.S. Pat. No. 4,578,193 A, U.S. Pat. No. 6,444,150 B1, or JP 2007298455, or US 2007181501 A1.

In US 2008/0217248 A1 the column is filled via a valve comprising a central bore and a nozzle. After introduction of the desired amount of stationary phase, the valve and nozzle are closed, thus maintaining pressure applied to the packing during filling. In EP 0696223 B1, the column is filled through an inlet element which is displaceable axially in relation to the column. Pressure applied to the packing during filling is maintained by displacing the inlet element towards the column after completion of the filling.

US 2008/0099402 A1, by the same applicant, discloses a column device comprising a separator for separating sections of the stationary phase and which is force-coupled with the housing.

WO 2006125564 A2 discloses elements for separating substances by distributing between a stationary and a mobile phase. The separating elements comprise any stationary phase and a support element. The separating elements are part of a set that is provided with at least two separating elements encompassing different stationary phases. The set comprises at least three pieces of each type of separating element with a specific stationary phase. The separating elements can be coupled to each other or interconnected in another manner so as to form a separating device.

WO 2007005508 A2 describes making an inexpensive chromatographic column. Column walls and a column end with a port are molded integrally from plastic. A closure is integrally molded with a port as well.

US 2005161382 A1 teaches forming a column by placing a frit in proximity to a distal end of a tube having an internal bore adapted to receive packing material for selectively interacting with an analyte of interest in a sample. The frit is then laser welded to the tube and packing material is inserted within the internal bore of the tube.

International Application WO 2010/083891 A1, by the same applicant, discloses a separation device having a separation chamber for housing a stationary phase configured for separating compounds of a fluid sample. The separation device comprises a filling port configured for filling the stationary phase through a filling channel into the separation chamber. Further, the separation device comprises a locking piece comprising the filling channel and being configured to move the filling channel from a first position to a second position. In the first position the filling channel is opening into the separation chamber for filling the stationary phase into the separation chamber. In the second position the separation chamber is locked against the filling channel.

### SUMMARY

It is an object of the invention to provide an improved filling/packing of separation devices. The object is solved by the independent claim(s). Further embodiments are shown by the dependent claim(s).

According to the present invention, a separation device is provided having a separation chamber for housing a packing material representing a stationary phase. In application, the packing material is used for separating compounds of a fluid sample, which is preferably provided in a mobile phase being moved through the stationary phase. The separation device comprises a first separation device element, a second separation device element, and a coupling member. The coupling member is configured for coupling the first separation device element and the second separation device element to provide the separation chamber. The first and second separation device elements each comprises a retaining element configured for retaining the packing material within the separation chamber.

In contrast to conventional separation devices wherein typically a tubing is closed on each side with a respective retaining element, embodiments of the invention provide two (or more) “half elements” (the first and second separation device elements), which are then coupled to provide the separation chamber of the separation device. In other words, the separation device is assembled by coupling the two half elements, so that the thus resulting separation chamber is closed on either side by the retaining elements of the two half elements. In conventional separation devices, the cavity provided in a corresponding separation device element is usually closed with a second retaining element, as disclosed e.g. in the aforementioned WO 2006125564 A2. Accordingly, in such conventional separation devices when coupling plural separation device elements, as in the WO 2006125564 A2, two retaining elements (i.e. one of each separation device element) are directly coupled in series (either more or less directly abutting to each other or coupled for example by a capillary) at the interface between the two separation device elements. Embodiments of the invention thus allow reducing dispersion and/or band broadening (also referred to as peak broadening) by reducing dead volume.

While the retaining element may be removeably coupled to the respective separation device element, the retaining element is preferably fixedly coupled to the respective separation device element thus providing an integral part of the separation device element. Such “integral” separation device elements can be preassembled and might already been designed in order to minimize dead volume. Preferably, the retaining element can be fixedly coupled to the respective separation device element by diffusion bonding, reactive joining, gluing, providing an adhesive substance, welding, mechanical pressing, shrinking, and any other suitable way of fixedly joining components. As an example, diffusion bonding as described in chapter 21.5 of “Bonding Processes”, M. Powers, S. Sen, T. Nguyentat, O. Knio and T. Weihs, in CRC Materials Processing Handbook, J. Groza, M. Powers, E. Lavernia and J. F. Shackelford, Eds., Taylor and Francis Group, New York, 2007, or reactive joining as described in chapter 21.6 thereof can be applied, and the teaching of that document shall be incorporated herein by reference.

Fixedly coupling the retaining element to the respective separation device element can have the advantage that the resulting separation device has the separation chamber being closed on either side by fixedly coupled retaining elements. It is to be understood that fixedly coupled retaining elements generally avoid that the mobile phase may bypass the retaining element and creep or flow outside the retaining element, for example, at the interface between the retaining element and the housing (e.g. a tubing) bearing the retaining element. To avoid such bypassing becomes increasingly important when applying higher pressure, for example beyond 1000 bar, and sealing the retaining element becomes a critical issue. It is also to be understood that such bypassing of the mobile phase around the retaining element may cause loss in accuracy or may cause sample cross contamination, so that sample analytes of a previous run can affect and may be detected in a later measurement and thus negatively infect the separation.

In one embodiment, each of the first and second separation device elements comprises a cavity (which might also be referred to as “lumen”). Each cavity is configured to receive and partly house at least a portion of the packing material. Such cavity may be provided by a tubing closed on one side by the respective retaining element. It is to be understood that the term “tubing” is not limited to substantially circular cross section type tubular shapes but may also cover elliptical, square, rectangular or any other suitable geometric shaping. Each cavity may have either the same or a different dimension and/or volume as desired or required for the respective application.

In one embodiment, the separation chamber is provided by a first separation device element. The retaining element of the second separation device element closes the separation chamber on one side, while the retaining element of the first separation device element is closing the separation chamber on the other side. The coupling member in such embodiment is configured for coupling the first and second separation device elements both having the same sense of direction (with respect of the arrangement of the retaining element and the separation chamber along a flow path of the fluid). In other words, each separation device element (before being coupled to another separation device element) is closed on one side by its respective retaining element and open on the other side. In such embodiments, the open side of the first separation device element is coupled to the “closed” side (i.e. the retaining element) of the second separation device element. Both separation device elements are arranged with both openings facing into the same direction, and accordingly both “closed” sides also arranged facing into the same direction (opposite to the open sides).

A third separation device element may then be provided which also comprises a retaining element. The third separation device element may be coupled to the second separation device element to provide a second separation chamber. Accordingly, further separation device elements can be coupled—mutatis mutandis—to provide plural separation chambers in series. The separation chambers might be used with either the same or different packing materials, in the latter case resulting in different separation properties in each separation chamber. As an example, one separation chamber can be filled with a packing material to provide a guarding or trapping column, while the other separation chamber is filled with a packing material to provide the intended separation.

In one embodiment having plural separation chambers, the selectivity of a chromatographic application can be increased or adjusted by selecting/adjusting the length of each separation chamber, for example by having separation chambers with the same or different lights and/or the same or different packing material. Alternatively or in addition, the inner diameter of the separation chambers can be varied, for example to reduce dispersion and/or to influence a pressure drop as well as effects on a longitudinal and/or radial temperature gradient resulting from high pressure application.

The retaining element of the third separation device element can be arranged to close the second separation chamber. This can be done, as will also be explained later, by arranging the third separation device element in opposite direction than the second (and first) separation device element(s), so that the open sides of the second and third separation device elements are facing towards each other. This results in a separation device with two separation chambers.

In one embodiment, the separation chamber is provided by the first and second separation device elements, wherein the retaining elements of the first and second separation device elements are closing the separation chamber on either side. In such embodiment the two half elements are arranged in “opposite” direction, so that the open sides of the first and second separation device elements are facing each other when being coupled together. Accordingly, the separation chamber results from cavities of both the first and second separation device elements. In such embodiments, each separation device element can be packed against its respective retaining element and the separation chamber is then closed by coupling the two separation device elements (in opposing direction with the openings facing each other) together. This can lead to a higher separation performance of the separation device with respect to a separation device being packed only in the direction of one retaining element, as in most conventionally available chromatographic columns. As a result of routine column loading experience under manufacturing conditions, it has been known in conventional applications that loading recipes building up chromatographic packings may show a bed density effect along the filled column tube, which can adversely affect column longevity.

In one embodiment, the separation chamber is provided by the cavity of the first separation device element. The retaining element of the second separation device element closes the separation chamber. A third separation device element (also having a respective retaining element) may then be coupled to the second separation device element to provide a second separation chamber. The second separation chamber may be provided by the cavity of the second separation device element with the retaining element of the third separation device element closing the second separation chamber. Alternatively or in addition, the second separation chamber may be provided by the cavities of both the second and third separation device elements, wherein the retaining elements of the second and third separation device elements are closing the second separation chamber.

The separation chamber may also be provided by the first and second separation device elements, wherein the retaining elements of both the first and second separation device elements are closing the separation chamber.

In one embodiment, the retaining elements of the first and second separation devices are closing the separation chamber, preferably on opposing sides.

In one embodiment, at least one of the first separation device element and the second separation device element comprises an elongation element for elongating the first separation chamber. The elongation element, which can be a tubing (preferably open on both sides), can be coupled to the respective separation device element by any other suitable type of connection or coupling, such as a screw connection, a threaded connection, a jam connection, a deadlock connection, a welding connection, a laser welding connection, and/or a reactive joining process. This allows to design or adjust the length and also volume of the first separation chamber as desired or required by a certain application. It is clear that the number of elongation elements to be coupled is only limited by the actual application, so that, for example, 2-5 elongation elements are coupled to one respective separation device element or one or more to the first separation device element and one or more to the second separation device element. When filling the respective separation device element with one or more elongation elements, the filing process might be applied sequentially, so that first the separation device element is filled with the stationary phase material, then the first elongation element is coupled and filled (with the same or a different stationary phase material), then the next elongation element is coupled and filled (with the same or a different stationary phase material), etc. Reactive joining can be preferably applied for coupling the elements. As a result, the separation device element may comprise one or more of such elongation elements, but nevertheless only have one retaining element (at the end of the separation device element opposing the side where the one or more of such elongation elements are coupled to.

The coupling member may comprise a screw connection, a threaded connection, a jam connection, a deadlock connection, a welding connection, a laser welding connection, and/or any other suitable type of connection or coupling for coupling the first and second separation device elements.

The coupling member may comprise a filling port configured to fill the separation device with the packing material. Such coupling member can be embodied as disclosed in the aforementioned WO 2010/083891 A1; the teaching thereof shall be incorporated herein by reference.

The retaining element may comprise a filter, a frit, a screen, a mesh, a perforated plate, a porous material, and/or any other element suitable for retaining the packing material within the separation chamber. Alternatively or in addition, a part (e.g. a small fraction) of the packing material may be joined or glued together, e.g. resulting from a thermal process (such as heating), a chemical process (condensation process e.g.), an adhesive material, mechanical jamming or any other suitable way for joining the packing material together as known in the art. In order to retain the packing material within the separation chamber, the retaining element preferably comprises a plurality of flow paths through the retaining element, each having a maximum (or maximum average) diameter being smaller than the smallest (or average smallest) particle of the packing material rated to be retained in the separation chamber.

The separation device may have a first port for receiving a mobile phase (which might be referred to as mobile phase inlet) and a second port for outletting the mobile phase (which might be referred to as mobile phase outlet). The first port may comprise the retaining element of the first separation device element, and the second port may comprise the retaining element of the second separation device element. Each port may comprise further components, such as fittings, tubings, or any other connection interface, in particular for coupling the separation device to a fluid flow path and/or other components, as well-known in the art.

Embodiments of the inventions comprise a method of providing a separation device having a separation chamber for housing a packing material representing a stationary phase configured for separating compounds of a fluid sample. The separation device comprises a first separation device element and a second separation device element. Each of the first and second separation device elements comprises a retaining element configured to retain the packing material within the separation chamber. The method comprises filling the first separation device element with at least a portion of the packing material, and coupling the first separation device element and a second separation device element to provide the separation chamber. In embodiments, the first and second separation device elements are coupled in the same sense of direction, so that the retaining element of the second separation device element closes the separation chamber as provided by the first separation device element and which is filled with the packing material. Embodiments of the method also provide coupling an open side of the first separation device element to the retaining element of the second separation device element, thus closing the separation chamber being filled with the packing material.

In embodiments, the second separation device element is filled with a portion of the packing material. The first and second separation device elements are coupled in opposite directions, so that the separation chamber is provided by the first and second separation device elements with the retaining elements of both first and second separation device elements closing the separation chamber. Alternatively or in addition, an open side of the first separation device element may be coupled to an open side of the second separation device element, so that the separation chamber is provided by the first and second separation device elements, again with the retaining elements of both the first and second separation device elements closing the separation chamber.

In embodiments, each separation device element comprises a tube or tubing, with the respective retaining element being coupled to the tubing. The tubing might have at least a section with a cross section being substantially circular, oval, elliptical or rectangular. While preferably the tube is provided having a continuous cross sectional shape and/or a continuous and uniform cross section, embodiments might comprise variations and combinations of different cross sectional shapes and sizes.

In one embodiment, the separation device is embodied in a microfluidic device having a microfluidic channel in a substrate (which substrate might be a glass, ceramic, metal, plastic, etc. material or a combination thereof). The separation device might be provided as a section of the microfluidic channel, as disclosed by the applicant e.g. in U.S. Pat. No. 5,500,071 A or EP 1577012 A1, which teaching with respect to microfluidic column devices shall be incorporated herein by reference.

In one embodiment, the separation device is embodied as a separation capillary to be used in a CE application, as disclosed e.g. in U.S. Pat. No. 5,858,241 A or on www.chem.agilent.com with respect to the Agilent Capillary Electrophoresis System, both by the same applicant. The teaching thereof shall be incorporated herein by reference.

In one embodiment, the separation device is comprised in a fluid separation system, which is provided for separating compounds of a sample fluid in a mobile phase. The fluid separation system comprises a mobile phase drive, such as pumping system, configured to drive the mobile phase through the fluid separation system. The separation device is provided for separating compounds of the sample fluid in the mobile phase. The fluid separation system might further comprise one or more of the following: a sample injector to introduce the sample fluid into the mobile phase, a detector to detect separated compounds, a collection unit to collect separated compounds, a data processing unit processed data received from the fluid separation system, and a degassing apparatus for degassing the mobile phase before being provided to the separation device.

In one embodiment a fluid separation system is provided for separating compounds of a sample fluid in a mobile phase. When a mobile phase including a fluidic sample passes through the fluidic device, for instance driven by high pressure, the interaction between the column packing and the fluidic sample may allow for separating different components of the sample, as performed in a liquid chromatography device. The fluid separation system comprises a mobile phase drive, such as pumping system, configured to drive the mobile phase through the separation system, and a separation unit in accordance to the aforementioned, such as a chromatographic column, configured for separating compounds of the sample fluid in the mobile phase.

Embodiments of the fluid separation system may comprise a sample injector configured to introduce the sample fluid into the mobile phase, a detector configured to detect separated compounds of the sample fluid, a collection unit configured to collect separated compounds of the sample fluid, a data processing unit configured to process data received from the fluid separation system, and/or a degassing apparatus configured for degassing the mobile phase.

Embodiments of the present invention might be embodied based on most conventionally available HPLC systems, such as the Agilent 1290 Series Infinity system, Agilent 1200 Series Rapid Resolution LC system, or the Agilent 1100 HPLC series (all provided by the applicant Agilent Technologies—see www.agilent.com—which shall be incorporated herein by reference). Alternatively, embodiment of the invention may also be applied in gas chromatography.

The separating device preferably comprises a chromatographic column providing the stationary phase. The column might be a glass, plastics or steel tube (e.g. with a diameter from 50 μm to 5 mm and a length of 1 cm to 1 m) or a microfluidic column (as disclosed e.g. in the aforementioned in U.S. Pat. No. 5,500,071 A or EP 1577012 A1 or the Agilent 1200 Series HPLC-Chip/MS System provided by the applicant Agilent Technologies, see e.g. http://www.chem.agilent.com/Scripts/PDS.asp?IPage=38308).

For example, a slurry mixture between a liquid and the stationary phase may be prepared and then be poured and pressed into the column. The individual components may be retained by the stationary phase according to their differences in physical adsorption behaviors. At the end of the column they elute one at a time. During the entire chromatographic process the different analytes, dissolved in the mobile phase eluent might be also collected in a series of fractions. The stationary phase or adsorbent in column chromatography usually is a solid material, especially in case of Liquid Chromatography. Liquids as adsorption material, especially immobilized onto a solid material, is a different approach in Gas Chromatography. In Liquid-Liquid chromatography two liquids, different in their adsorption/desorption characteristics also play an important role. The most common stationary phase for column chromatography is silica gel, followed by polymeric materials or combinations of both and alumina. Cellulose powder has often been used in the past.

The mobile phase (or eluent) can be either a pure solvent or a mixture of different solvents. It can be chosen e.g. to minimize the retention of the compounds of interest and/or the amount of mobile phase to run the chromatography. The mobile phase can also been chosen so that the different compounds can be separated effectively. The mobile phase might comprise an organic solvent like e.g. methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents. Alternatively, the mobile phase may also be a gas, such as generally known in gas chromatography.

The sample fluid might comprise any type of liquid, gas or even solid material before being dissolved within a liquid. Its origin might be of natural characteristics, such as natural sample like juice or a gas like methane, body fluids like plasma or it may be the result of a chemical synthetic reaction process or biochemical reaction process like from a fermentation broth. It may also comprise (but not limited to) sea water, mineral oil or any rectification or cracking fractions of it, extracts of soil, plants or artificial materials such as plastics, as well as alcoholic or alcohol-free beverages.

In case of Liquid Chromatography, especially High Performance Liquid Chromatography, the pressure in the mobile phase might range from 2-200 MPa (20 to 2000 bar), in particular 5-150 MPa (50 to 1500 bar), and more particular 50-120 MPa (500 to 1200 bar).

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied in or by the control unit.

### BRIEF DESCRIPTION OF THE DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s).

FIG. 1 shows a liquid separation system 10, in accordance with embodiments of the present invention, e.g. used in high performance liquid chromatography (HPLC).

FIG. 2 illustrates a typical embodiment of a chromatographic column 30 as separation device.

FIGS. 3A, 3B, and 4 show in schematic drawings an embodiment of a separation device 30.

FIG. 5 shows an embodiment, wherein the tubings 330, 350 to be coupled differ in end geometry of the sides to be coupled to.

### DETAILED DESCRIPTION

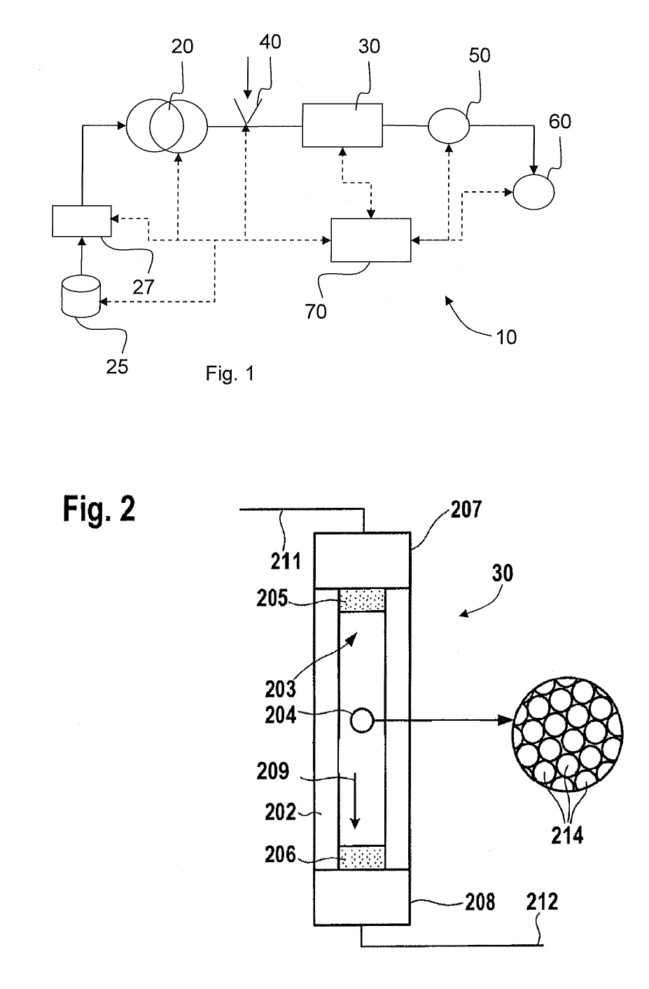

Referring now in greater detail to the drawings, FIG. 1 depicts a general schematic of a liquid separation system 10. A pump 20 receives a mobile phase from a solvent supply 25, typically via a degasser 27, which degases and thus reduces the amount of dissolved gases in the mobile phase. The pump 20—as a mobile phase drive—drives the mobile phase through a separating device 30 (such as a chromatographic column) comprising a stationary phase. A sampling unit 40 can be provided between the pump 20 and the separating device 30 in order to subject or add (often referred to as sample introduction) a sample fluid into the mobile phase. The stationary phase of the separating device 30 is configured for separating compounds of the sample liquid. A detector 50 is provided for detecting separated compounds of the sample fluid. A fractionating unit 60 can be provided for outputting separated compounds of sample fluid.

While the mobile phase can be comprised of one solvent only, it may also be mixed from plural solvents. Such mixing might be a low pressure mixing and provided upstream of the pump 20, so that the pump 20 already receives and pumps the mixed solvents as the mobile phase. Alternatively, the pump 20 might be comprised of plural individual pumping units, with plural of the pumping units each receiving and pumping a different solvent or mixture, so that the mixing of the mobile phase (as received by the separating device 30) occurs at high pressure and downstream of the pump 20 (or as part thereof). The composition (mixture) of the mobile phase may be kept constant over time, the so called isocratic mode, or varied over time, the so called gradient mode.

A data processing unit 70, which can be a conventional PC or workstation, might be coupled (as indicated by the dotted arrows) to one or more of the devices in the liquid separation system 10 in order to receive information and/or control operation. For example, the data processing unit 70 might control operation of the pump 20 (e.g. setting control parameters) and receive therefrom information regarding the actual working conditions (such as output pressure, flow rate, etc. at an outlet of the pump). The data processing unit 70 might also control operation of the solvent supply 25 (e.g. setting the solvent/s or solvent mixture to be supplied) and/or the degasser 27 (e.g. setting control parameters such as vacuum level) and might receive therefrom information regarding the actual working conditions (such as solvent composition supplied over time, flow rate, vacuum level, etc.). The data processing unit 70 might further control operation of the sampling unit 40 (e.g. controlling sample injection or synchronization sample injection with operating conditions of the pump 20). The separating device 30 might also be controlled by the data processing unit 70 (e.g. selecting a specific flow path or column, setting operation temperature, etc.), and send—in return—information (e.g. operating conditions) to the data processing unit 70. Accordingly, the detector 50 might be controlled by the data processing unit 70 (e.g. with respect to spectral or wavelength settings, setting time constants, start/stop data acquisition), and send information (e.g. about the detected sample compounds) to the data processing unit 70. The data processing unit 70 might also control operation of the fractionating unit 60 (e.g. in conjunction with data received from the detector 50) and provides data back.

FIG. 2 illustrates a typical embodiment of a chromatographic column 30 as separation device. The column 30 comprises a housing 202 which—in this exemplary embodiment—is shaped as a hollow cylinder or tube. Within the housing 202, a column chamber—as a separation chamber 203—is defined. In case of a tube shape or hollow bore, the separation chamber 203 provides a tubular reception. The separation chamber 203 is or is to be filled with a stationary phase 204, such as a package material or package composition. In the schematic drawing of FIG. 2, the stationary phase 204 shall be indicated by an exemplary element of packing material. Typically, the separation chamber 203 is packed with the packing material 204 A process of loading the separation chamber 203 should be designed to avoid any void volumes in order to keep sample dispersion to be introduced into the mobile phase as small as possible.

The column 30 further comprises a first retaining element 205 close to an inlet port 207 of the column 30 and a second retaining element 206 provided at an outlet port 208 of the column 30. Each of the retaining elements 205 and 206 are provided to retain the package composition 204 within the separation chamber 203 of the column tube 202 and may be embodied by a filter, a frit, a mesh, a disk, a portion of the packing material 204 joint together (e.g. by thermal, chemical or adhesive processing), or a combination thereof, as readily known in the art. Adequate fitting elements (for coupling elements such as connectors, conduits, capillaries, etc.) might be attached to or provided by one or both of the first and second ports 207 and 208.

The column 30 receives the mobile phase (e.g. from the pump 20 of FIG. 1), for example through a connection tube 211, e.g. a capillary (e.g. a metal capillary tube). The mobile phase enters through the inlet port 207 and the first frit 205 into the separation chamber 203. Within the separation chamber 203, the mobile phase interacts with the stationary phase 204, and different compounds of a sample fluid introduced into the mobile phase may thus be separated. After having left the separation chamber 203, that is to say after having passed the second retaining element 206 and the outlet port 208, a second tube or pipe 212 (e.g. a capillary such as a metal capillary) may transport the mobile phase (including the separated compounds) e.g. towards the detector 50 of FIG. 1. A typical packing composition 204 may comprise a plurality of silica gel beads 214, as schematically indicated in FIG. 2, which may be loaded under pressure into the separation chamber 203 of the column tube 202. A flowing direction of the mobile phase through the column 30 is denoted with reference numeral 215.

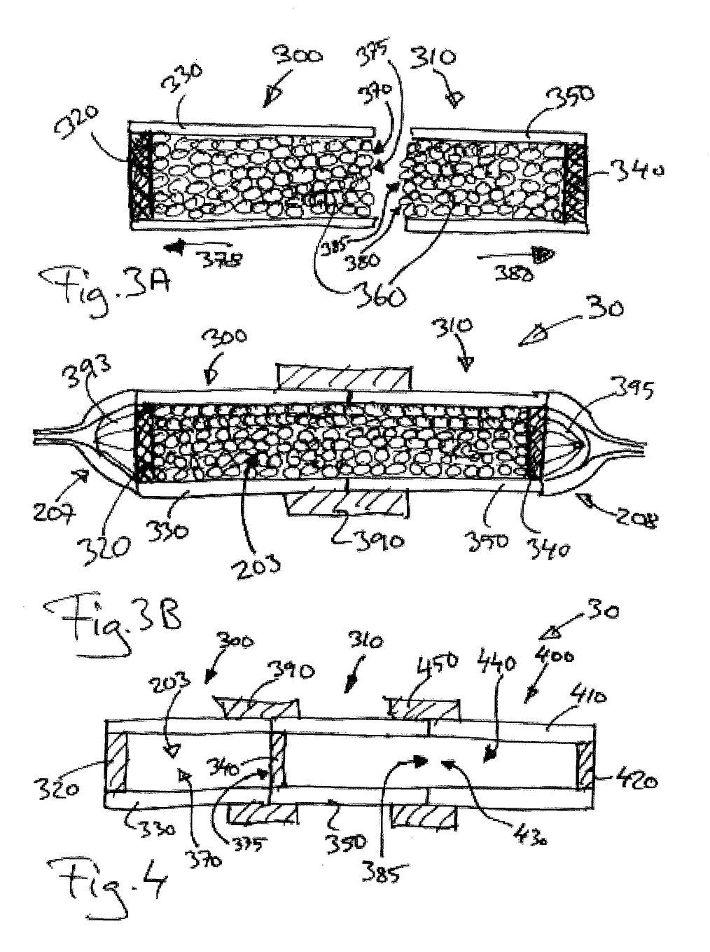

FIGS. 3A and 3B show—in schematic drawings—an embodiment of a separation device 30 comprising a first separation device element 300 and a second separation device element 310. In FIG. 3A, the first separation device element 300 comprises a retaining element 320 coupled into a tubing 330. Accordingly, the second separation device element 310 comprises a retaining element 340 coupled into a tubing 350. The retaining element 320 and 340, which may be a frit, disc, mesh or filter in this embodiment, may be removeably or fixedly coupled into the respective tubings 330 and 350.

Each of the first and second separation device elements 300 and 310 are loaded with a packing material 360 representing the stationary phase 204, as known in the art. In the first separation device element 300, the packing material 360 has been loaded into a cavity 370 resulting from the tubing 330 being closed on one side by the retaining element 320 and having an open side 375 on the opposing end of the tubing 330. The packing material 360 has been filled and loaded against the retaining element 320 as indicated by arrow 378. Accordingly, the second separation device element 310 provides a cavity 380 resulting from the tubing 350 being closed on one end by the retaining element 340 and having an open end 385 on the opposing side of the tubing 350. The second separation device element 310 has also been filled and loaded with the packing material 360 in a direction 388 against the retaining element 340.

FIG. 3B illustrates schematically the combination of the two separation device elements 300 and 310 to provide the separation device 30. As apparent from FIG. 3B, the first separation device element 300 and the second separation device element 310 have been coupled together by a coupling member 390, so that the first and second separation device elements 300 and 310 are abutting against each other at their open sides 375 and 385. Accordingly, the separation chamber 203 (see FIG. 2) is provided in the embodiment of FIG. 3b by the two tubings 330 and 350 abutting at their open sides 375 and 385 and being closed at a opposing ends by the retaining elements 320 and 340.

In order to reduce dead volume which may result from coupling the first and second separation device elements 300 and 310 together, at least one of the first and second separation device elements 300 and 310 may be slightly overfilled, as indicated by the second separation device element 310 in FIG. 3A, wherein the packing material 360 is slightly protruding over the open side 385. When joining the first and second separation device elements 300 and 310 to provide the separation device 30 the overfilled portion will press against the packing material 360 of both the first and second separation device elements 300 and 310 thus reducing, closing, or taking the level of potential void volumes.

FIG. 3B further shows—at opposing sides of the separation device 30—the inlet ports 207 and the outlet ports 208, which might be an integral part of the half elements provided by the first and second separation device elements 300 and 310 or be removeably coupled thereto, as readily known in the art. Aspects of optimal fluid geometries and thus minimization of peak dispersion are preferably taken into account as well known in the art.

In the example of FIG. 3B, the inlet port 207 comprises a distribution cone 393 for distributing the mobile phase to the retaining element 320 over the entire area as homogeneously as possible. Accordingly, the outlet port 208 comprises a collecting cone 395 collecting the mobile phase after having passed the retaining element 340. Inlet port 207 and outlet port 208 can be provided identical. However, they also may differ in some regard, for example, if specific different connections for special applications might prosper from specifically fitted geometries—e.g. for taking into account the aspect of minimal fluid dispersion.

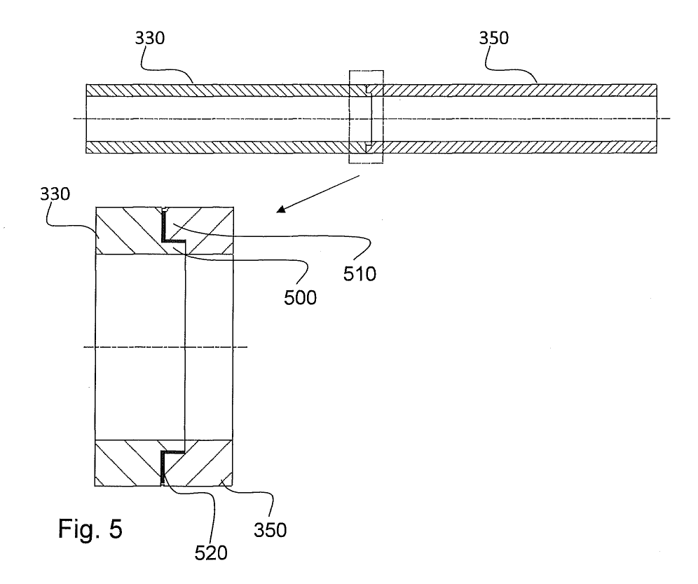

In the embodiments of FIGS. 3A and 3B, the first and second separation device elements 300 and 310 have been coupled together at their open ends 375 and 385. However, the half elements of the first and second separation device elements 300 and 310 may also be coupled together with the same sense of direction as indicated in FIG. 4. Accordingly, the separation chamber 203 is then provided only by the cavity 370 of the first separation device element 300 and closed at opposing ends by the retaining elements 320 and 340, with the retaining element 340 closing at the open side 375 of the first separation device element 300.

In the embodiment of FIG. 4, a third separation device element 400, also comprising a tubing 410 and a retaining element 420, is abutting with its open side 430 against the open side 385 of the second separation device element 310, thus closing a second separation chamber 440. A second coupling member 450 is provided for coupling the second and third separation device element 310 and 400 together.

With FIG. 4 showing the separation device 300 having two separation chambers 203 and 440, it becomes apparent that further separation chambers can be achieved by coupling additional separation device elements together in accordance with the aforesaid. As an example, a fourth separation device element (not shown in the figures) could be coupled with its open end to the retaining element 420, etc. Alternatively or in addition, the third separation device element 400 can be coupled to the second separation device element 310 in the same sense of direction (not shown in FIG. 4), so that the open side 385 of the second separation device element 310 closes against the retaining element 420 of the third separation device element 400, etc.

The separation device elements (e.g. 300, 310, 400) may be provided each having the same shape, volume and dimension. Alternatively, the separation device elements may be provided for example having different lengths (as indicated in FIG. 3A) or might show different internal diameters. Further, the separation device elements might be loaded with the same or different packing material. In the latter case, a “stationary phase gradient” as illustrated in the aforementioned WO 2006/125564 A2 might be achieved. The teaching of that document with respect to such stationary phase gradient shall be incorporated herein by reference.

The coupling members 390 and 450 can be embodied, for example, using any kind of coupling as known in the art, such as screw fitting, internal and/or external screw thread, snap fittings, press fit, etc. Sealing is preferably provided, e.g. by using sealing rings, where the tubings (e.g. 330 and 350) abut.

Each retaining element 320, 340 can be fixed to the respective tubing 330, 350 as known in the art and as mentioned in the foregoing description. In particular, screw connection, clamp connection, press fit, reactive joining, diffusion process, etc. have been found useful.

The retaining element 320, 340 may comprise a filter, a frit, a screen, a mesh, a perforated plate, a porous material, and/or any other element suitable for retaining the packing material within the separation chamber. Alternatively or in addition, a small fraction of the packing material may be joined or glued together, e.g. resulting from a thermal process (such as heating), a chemical process (e.g. condensation process), etc.

In one embodiment, the retaining element 320, 340 comprises a frit or metallic screen and is joined together with the respective tubing 330, 350 by use of a diffusion process. In this embodiment, the frit or metallic screen shows a porous network embedded into a metallic ring. The combination of both is located inside one end of the tubing 330, 350. All three parts will be joined together during the diffusion bonding process by using the required heat and pressure. Pressure and temperature programming over time can be adjusted to result in a good joining.

Another alternative to join together a metallic screen 320, 340 with a chromatographic tube 330,350 might be fabricating the screen 320, 340 having a certain rigid outer surface to give a perfect contact to the tube 330,350 or even to control the diffusion process in such a way that the wire ends of the screen 320, 340 are directly joined to the end of the tube 330,350 without leaving open pores directly neighbored to the inner wall of the joined tube.

FIG. 5 shows an embodiment, wherein the tubings 330, 350 to be coupled differ in end geometry of the sides to be coupled to. In the example of FIG. 5, the tubing 330 is provided with a male end geometry 500, whereas the tubing 350 is provided with a female end geometry 510, as can be best seen in the enlarged detail.

In the embodiment of FIG. 5, the tubings 330, 350 are joined together during a reactive joining process by use of reactive multilayer foils 520. Reactive multilayer foils 520 are a new class of nano-engineered materials that are typically fabricated by vapor depositing hundreds of nanoscale layers that alternate between elements with large negative heats. An example of such a reactive foil can be Alumina, Magnesia.

Alternatively or in addition, a suitable solder or braze (like INCUSIL or combination of different other inorganic alloys or alloy like material combinations), it is possible to join together a variety of different metal or ceramic type materials by some kind of melting process.

In general, the self propagating bonding process can be driven by a reduction in chemical bond energy. During this exothermic process induced by a small, short thermal pulse a huge quantity of heat is generated by the reactive foil that allows atoms of different material layers to change their positions within their atom lattice structure and thus building up a new alloy lattice structure.

1. A separation device having a first separation chamber for housing a packing material representing a stationary phase configured for separating compounds of a fluid sample, the separation device comprising:
a first separation device element and a second separation device element, configured to be coupled together to provide the first separation chamber,
wherein each of the first separation device element and the second separation device element comprises a retaining element configured to retain the packing material within the first separation chamber, and
the first separation chamber is provided by the first separation device element and the second separation device, with the retaining elements of both the first separation device element and the second separation device closing the first separation chamber.

2. The separation device of claim 1, comprising at least one of:
the retaining element of at least one of the separation device elements is fixedly coupled to the respective separation device element;
the retaining element of at least one of the separation device elements is fixedly coupled to the respective separation device element by at least one of diffusion bonding, reactive joining, gluing, adhesive substance, welding, mechanical pressing, shrinking.

3. The separation device of claim 1, wherein
the retaining element of at least one of the separation device elements is removeably coupled to the respective separation device element.

4. The separation device of claim 1, wherein
the coupling member is configured for coupling the first separation device element and the second separation device element by a reactive joining,

5. The separation device of claim 1, comprising
a third separation device element comprising a retaining element and coupling to the second separation device element to provide a second separation chamber.

6. The separation device of claim 5, comprising at least one of:
the retaining element of the third separation device element is closing the second separation chamber;
the retaining elements of both the third separation device element and the second separation device element are closing the second separation chamber;
each separation chamber comprises a different packing material;
the first separation chamber comprises a first packing material to provide at least one of a trapping column, a guard column, and a pre column.

7. The separation device of claim 1, wherein
each of the first separation device element and the second separation device element comprises a cavity configured to receive and partly house at least a portion of the packing material.

8. The separation device of claim 7, wherein
the first separation chamber is provided by the cavity of the first separation device element with the retaining element of the second separation device element closing the first separation chamber.

9. The separation device of claim 8, wherein
a third separation device element comprising a retaining element and coupling the second separation device element to provide a second separation chamber.

10. The separation device of claim 9, comprising at least one of:
the second separation chamber is provided by the cavity of the second separation device element with the retaining element of the third separation device element closing the second separation chamber;
the second separation chamber is provided by the cavity of the second separation device element and the cavity of the third separation device element, with the retaining elements of the second separation device element and the third separation device element closing the second separation chamber.

11. The separation device of claim 1, comprising at least one of:
the first separation chamber is provided by the first separation device element and the second separation device, with the retaining elements of both first separation device element and the second separation device closing the first separation chamber;
the retaining elements of the first separation device element and the second separation device are closing the first separation chamber;
the retaining elements of the first separation device element and the second separation device are closing the first separation chamber on opposing sides.

12. The separation device of claim 1, comprising at least one of:
at least one of the first separation device element and the second separation device element comprises an elongation element for elongating the first separation chamber;
the coupling member comprises at least one of a screw connection, a threaded connection, a jam connection, a deadlock connection, a welding connection, a laser welding connection;
the coupling member comprises a filling port configured to fill the separation device with the packing material;
the retaining element comprises at least one of a filter, a frit, a screen, a mesh, a perforated plate, a porous material, a part of the packing material joined together, a porous material;
a first port for receiving a mobile phase, and a second port for outletting the mobile phase;
each separation device element comprises a tubing, with the respective retaining element being coupled to the tubing;
the tubing has at least a section with a cross-section substantially being one of: round, oval, elliptical, rectangular;
the separation device is or comprises at least one of: a chromatographic column, a tube type chromatographic column, a microfluidic column chip, a separation capillary for capillary electrophoresis or any other geometrical matter feasible for separation purposes;
the fluid sample is comprised in a mobile phase.

13. A fluid separation system for separating compounds of a sample fluid in a mobile phase, the fluid separation system comprising:
a mobile phase drive, preferably a pumping system, configured to drive the mobile phase through the fluid separation system;
a separation device, according to claim 1, configured for separating compounds of the sample fluid in the mobile phase.

14. The fluid separation system of claim 13, further comprising at least one of:
a sample injector configured to introduce the sample fluid into the mobile phase;
a detector configured to detect separated compounds of the sample fluid;
a collection unit configured to collect separated compounds of the sample fluid;
a data processing unit configured to process data received from the fluid separation system;
a degassing apparatus for degassing the mobile phase.

15. A method of providing a separation device having a first separation chamber for housing a packing material representing a stationary phase configured for separating compounds of a fluid sample, wherein the separation device comprises a first separation device element and a second separation device element, and each of the first separation device element and the second separation device element comprises a retaining element configured to retain the packing material within the first separation chamber, the method comprising:
filling the first separation device element with at least a portion of the packing material, and
coupling the first separation device element and a second separation device element to provide the first separation chamber, with the retaining elements of both the first separation device element and the second separation device closing the first separation chamber.

16. The method of claim 15, comprising at least one of:
the first separation device element and the second separation device element are coupled in the same sense of direction, so that the retaining element of the second separation device element closes the first separation chamber provided by the first separation device element and filled with the packing material;
coupling an open side of the first separation device element to the retaining element of the second separation device element thus closing the first separation chamber filled with the packing material.

17. The method of claim 13, further comprising
filling the second separation device element with a portion of the packing material, and at least one of:
coupling the first separation device element and the second separation device element in opposite directions, so that the first separation chamber is provided by the first separation device element and the second separation device with the retaining elements of both the first separation device element and the second separation device closing the first separation chamber;
coupling an open side of the first separation device element to an open side of the second separation device element, so that the first separation chamber is provided by the first separation device element and the second separation device element with the retaining elements of both first separation device element and the second separation device element closing the first separation chamber.

18. The method of claim 13, wherein coupling the first separation device element and the second separation device element comprises a reactive joining process.

19. A software program or product, stored on a non-transitory data carrier, for controlling or executing the method of claim 13, when run on a data processing system.

20. A separation device having a first separation chamber for housing a packing material representing a stationary phase configured for separating compounds of a fluid sample, the separation device comprising:
a first separation device element, a second separation device element, and a coupling member configured for coupling the first separation device element and the second separation device element to provide the first separation chamber,
wherein each of the first separation device element and the second separation device element comprises a retaining element configured to retain the packing material within the first separation chamber, and
the first separation chamber is provided by the first separation device element and the second separation device, with the retaining elements of both the first separation device element and the second separation device closing the first separation chamber.
